(19) United States
(12) Patent Application Publication
(10) Pub. No.: US 2011/0215202 A1
(43) Pub. Date: Sep. 8, 2011

(54) WING SPAR SPLICE JOINT

(75) Inventors: Charles A. Rhoden, Lake Stevens, WA (US); Stephen C. Daschel, Everett, WA (US); Randolph L. Henry, Arlington, WA (US); Russell E. Thibaut, Lake Stevens, WA (US)

(73) Assignee: GLOBAL AEROSYSTEMS, LLC, Everett, WA (US)

(21) Appl. No.: 12/962,506

(22) Filed: Dec. 7, 2010

Related U.S. Application Data
(60) Provisional application No. 61/267,299, filed on Dec. 7, 2009.

(51) Int. Cl. B64C 3/18

(52) U.S. Cl. 244/131

(57) ABSTRACT

A wing spar joint is provided for coupling the inboard ends of a right wing spar and a left wing spar. The wing spar joint comprises a forward fitting, an aft fitting, a spar cap a lower chord fitting and a strap member. A first plurality of fasteners secure the forward fitting and the aft fitting together through a web portion of the wing spars. A second plurality of fasteners secure the upper spar cap, the lower spar cap and the forward fitting together through upper chords of the wing spars. A third plurality of fasteners secure the lower chord fitting, the strap member and the forward fitting together through lower chords of the wing spars. The forward fitting, aft fitting, spar cap and strap member are thus secured together with the wing spars to form a rigid connecting joint at the inboard ends of the wing spars.

### CROSS-REFERENCES

This application is related to U.S. provisional application No. 61/267,299, filed Dec. 7, 2009, entitled “Spar Modification”, naming Stephen C. Daschel, Charles A. Rhoden, Randolph L. Henry and Russell E. Thibaut as inventors. The contents of the provisional application are incorporated herein by reference in their entirety, and the benefit of the filing date of the provisional application is hereby claimed for all purposes that are legally served by such claim for the benefit of the filing date.

### BACKGROUND

Right and left main wings of an aircraft are typically assembled individually and then attached to the fuselage. In some aircraft, each of the right and left main wings are generally equipped with a front spar and a rear spar that extend in the span direction. A plurality of structural members, such as stringers and ribs, connect the front spar and rear spar and form a skeletal structure or framework. The framework is overlaid with skin running substantially along the length of the wings. The skin may be fastened or joined to the structure or framework in a variety of ways, such as by adhesive, rivets, bolts or combinations thereof, and other suitable fastening devices.

A principal load-carrying member of the wing is the spar. The front spar and rear spar are each arranged to pass through the fuselage substantially transversely to the longitudinal axis of the aircraft and along the length of each of the wing portions. The outboard ends of the spar extend into each wing and are structurally connected to each wing panel. When the main wings are assembled individually a spar may comprise right and left spar halves. The inboard ends of the spar halves are inserted into the fuselage and joined. Suitable fittings are provided so as to bring about firm engagement between the spars, wings and the appropriate structural members of the fuselage so that loads can be transferred effectively from the wings into the fuselage.

A spliced joint between the inner ends of the right and left spar halves occurs approximately on the centerline of the fuselage. The joint includes connection fittings, which are intended to carry loads across the joint and to meet the bearing specifications for the joint. Bolts, preferably fitted with nuts on their threaded ends, are inserted through mating holes so as to fasten the spar halves securely together.

Existing wing front spar centerline splices experience high cyclic loading, both in terms of number of cycles and internal stresses, at critical splice component details. The result is crack initiation and growth due to metal fatigue which can result in catastrophic structural failure if not detected and fixed. One solution is an ongoing inspection program coupled with replacement of wing lower spar caps with production parts. The result is high ongoing maintenance costs for airplane owners.

For the foregoing reasons, there is a need for a new wing spar splice joint connection that strengthens the connection between spar halves. The new spar splice joint should include connection fittings which effectively handle loads across the joint. Ideally, the connection fittings and wing spar will have appropriately placed, corresponding mating holes for securing the spar halves and connection fittings.

### SUMMARY

A wing spar joint is provided for coupling the inboard ends of a right wing spar and a left wing spar. Each wing spar comprises an elongated structural member including a planar web portion terminating in longitudinal edges and a top chord and a bottom chord extending from the longitudinal edges of the web portion. The top and bottom chords terminate in longitudinal edges and include a flange integral with the longitudinal edge of each of the top chord and the bottom chord. The wing spar joint comprises a forward fitting adapted to be disposed against the forward surface of the web portion of the wing spars and spanning the joint defined by the inboard ends of the wing spars, and an aft fitting adapted to be disposed against the aft surface of the web portion of the wing spars and spanning the joint defined by the inboard ends of the wing spars. A spar cap includes an upper spar cap adapted to be disposed on the upper surface of the flange of the top chord, and a lower spar cap adapted to be disposed on the inner surface of the flange of the top chord. The upper spar cap and the lower spar cap span the joint defined by the inboard ends of the wing spars. A lower chord fitting is adapted to be disposed adjacent the lower chord of the wing spars and spans the joint defined by the inboard ends of the wing spars. A strap member is adapted to be disposed between the lower fitting and the lower chord of the wing spars and spans the joint defined by the inboard ends of the wing spars. A first plurality of fasteners are inserted through mating holes in the forward fitting, the web portion, and the aft fitting so as to secure the forward fitting and the aft fitting together through the web portion of the wing spars. A second plurality of fasteners are inserted through mating holes in the upper spar cap, the upper chord, the lower spar cap and the forward fitting for securing the upper spar cap, the lower spar cap and the forward fitting together through the upper chords of the wing spars. A third plurality of fasteners are inserted through mating holes in the lower chord fitting, the strap member, the lower chord and the forward fitting for securing the lower chord fitting, the strap member and the forward fitting together through the lower chord of the wing spars. The forward fitting, aft fitting, spar cap and strap member are thus secured together with the wing spars to form a rigid connecting joint at the inboard ends of the wing spars.

### BRIEF DESCRIPTION OF THE DRAWINGS

For a more complete understanding of the present invention, reference should now be had to the embodiments shown in the accompanying drawings and described below. In the drawings:

FIG. 1 is a front perspective view of a front spar showing a prior art splice joint.

FIG. 2 is a rear perspective view of the front spar and splice joint shown in FIG. 1.

FIG. 3 is a front elevation view of a splice joint operatively connected to a front spar

FIG. 4 is a partial cross-section view of the splice joint taken along line 4-4 of FIG. 3.

FIG. 5 is a partial cross-section view of the splice joint taken along line 5-5 of FIG. 3.

FIG. 6 is a top view of the mid-point of the splice joint shown in FIG. 3.

FIG. 7 is a rear elevation view of the splice joint operatively connected to a front spar as shown in FIG. 3.

FIG. 8 is a perspective view of a front fitting for use in the splice joint for a front spar as shown in FIG. 3.

FIG. 9 is a front elevation view of the front fitting shown in FIG. 8.

FIG. 10 is a rear elevation view of the front fitting shown in FIG. 8.

FIG. 11 is a perspective view of a lower fitting for use in the splice joint for a front spar as shown in FIG. 3.

FIG. 12 is a top plan view of the lower fitting shown in FIG. 11.

FIG. 13 is a bottom plan view of the lower fitting shown in FIG. 11.

FIG. 14 is a perspective view of a rear fitting for use in the a splice joint for a front spar as shown in FIG. 3.

FIG. 15 is a top plan view of the rear fitting shown in FIG. 14.

FIG. 16 is a front elevation view of the rear fitting shown in FIG. 14.

FIG. 17 is a front elevation view of a modified front spar for use with an embodiment of a splice joint, with webs removed for clarity.

FIG. 18 is a rear elevation view of a modified front spar as shown in FIG. 17 for use with an embodiment of a splice joint.

FIG. 19 is a rear perspective view of a steel strap for use in the splice joint for a front spar as shown in FIG. 3.

FIG. 20 is a top plan view of the steel strap shown in FIG. 19.

FIG. 21 is a rear perspective view of a modified splice joint on a front spar of an aircraft wing connected to rework tool fixture.

### DESCRIPTION

Certain terminology is used herein for convenience only and is not to be taken as a limitation on the invention. For example, words such as “upper,” “lower,” “left,” “right,” “horizontal,” “vertical,” “upward,” and “downward” merely describe the configuration shown in the FIGs. Indeed, the components may be oriented in any direction and the terminology, therefore, should be understood as encompassing such variations unless specified otherwise.

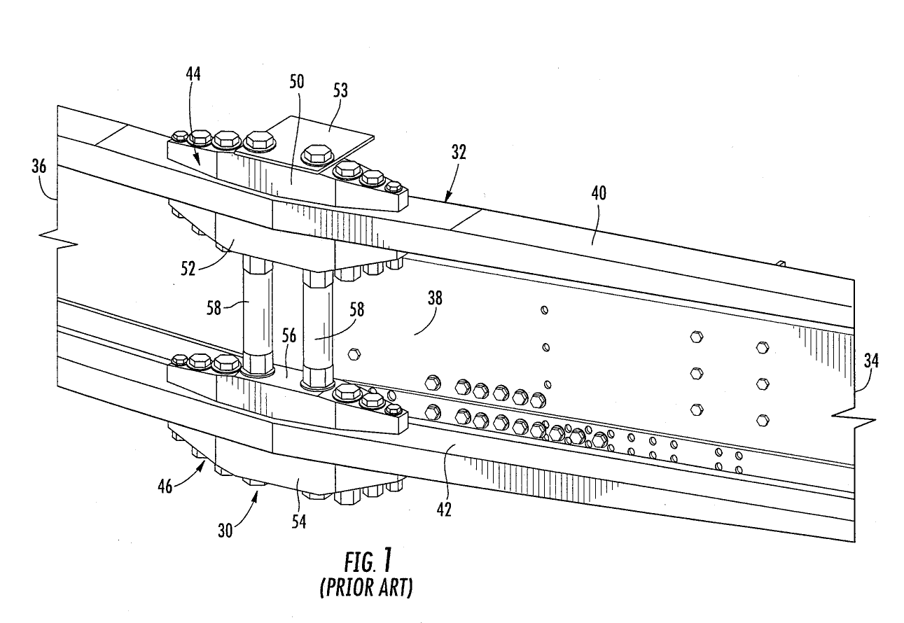

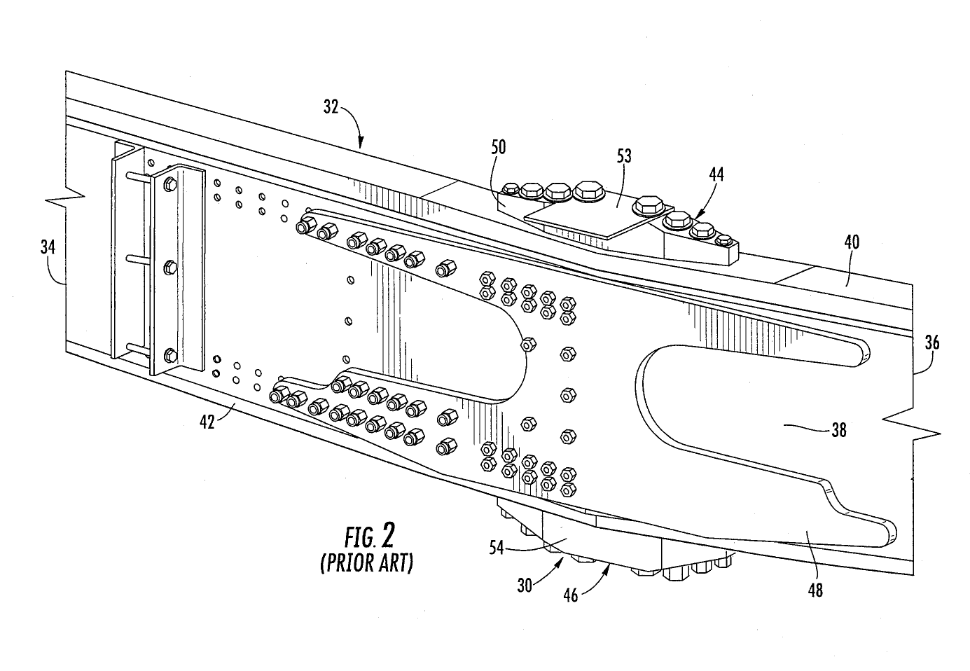

Referring now to the drawings, wherein like reference numerals designate corresponding or similar elements throughout the several views, a front spar and a conventional spar splice joint is shown in FIGS. 1 and 2 and generally designated at 30. The front spar 32 comprises a right portion 34 and a left portion 36 as seen in FIG. 1. The right portion 34 of the front spar 32 serves as a structural component of the right main wing and the left portion 36 of the front spar serves as a structural component of the left main wing. Each portion of the front spar 32 has an I-shaped cross-section, including a central web 38 and an upper chord 40 and a lower chord 42 at the top edge and bottom edge of the web, respectively. The upper chord 40 and lower chord 42 are “L”-shaped, having a first leg secured to the forward surface of the-web 38 and a second leg disposed at approximately a 90° angle with respect to the first leg and the web.

The right portion 34 and the left portion 36 of the front spar 32 are connected integrally on the center line of the aircraft fuselage at the spar splice joint 30. The conventional splice joint 30 comprises a plurality of connection fittings. Generally, the inner ends of the right portion 34 and the left portion 36 of the front spar 32 are abutted against each other and the connection fittings are positioned at the top, bottom and rear surfaces thereof, respectively. A plurality of holes for receiving fasteners are formed at predetermined intervals in the fittings and the front spar for rigidly securing the components.

The fittings of the conventional splice joint include an upper spar fittings 44, a lower spar fitting 46, and an aft splice plate 48. The upper spar 44 fittings comprises an upper spar upper fitting 50 and an upper spar lower fitting 52. The upper spar upper fitting 50 and the upper spar lower fitting 52 are connected through the upper chord 40 using eight bolts, four symmetrically spaced on each side of the spar joint. The two central bolts also secure an attachment plate 53 to the top of the upper spar upper fitting 50. The attachment is used to secure the spar to the aircraft frame. The lower block fitting 46 is a similar arrangement with a lower spar lower fitting 54 connected through the lower chord 42 to a lower spar upper fitting 56 using eight symmetrically arranged bolts. As shown in FIG. 1, the two innermost bolts are rigidly connected by two sleeves 58 secured at their ends to the nuts. Referring to FIG. 2, the aft splice plate 48 is a generally “I”-shaped piece fastened directly to the aft surface of the web 38 of the spar.

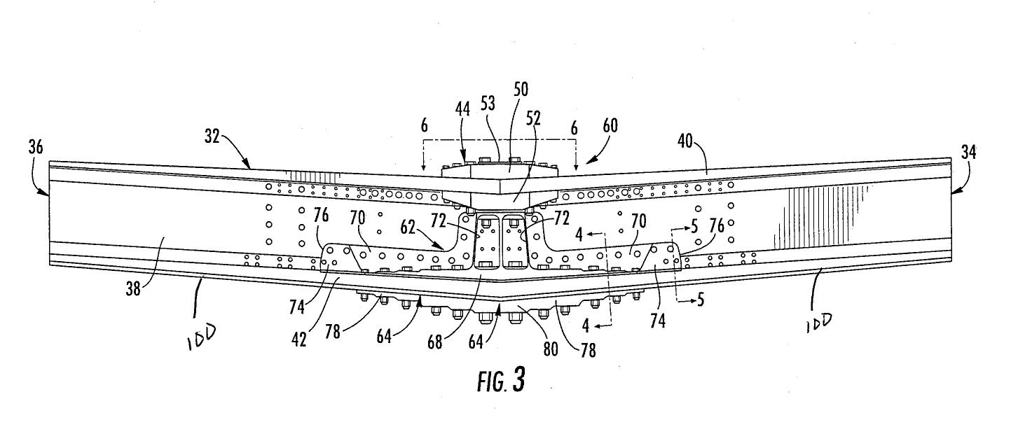

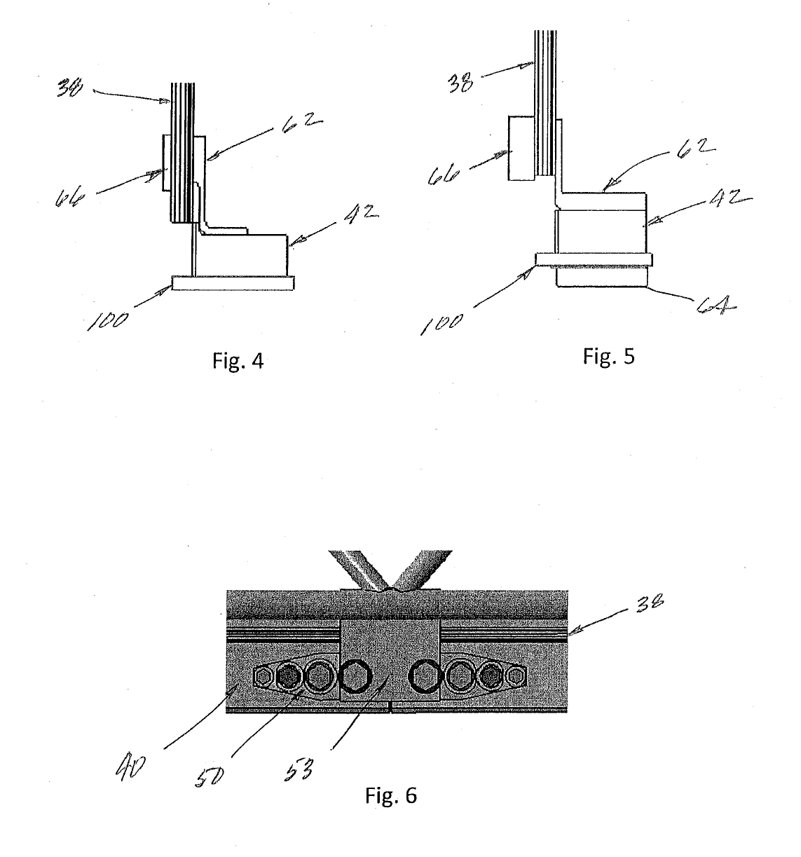

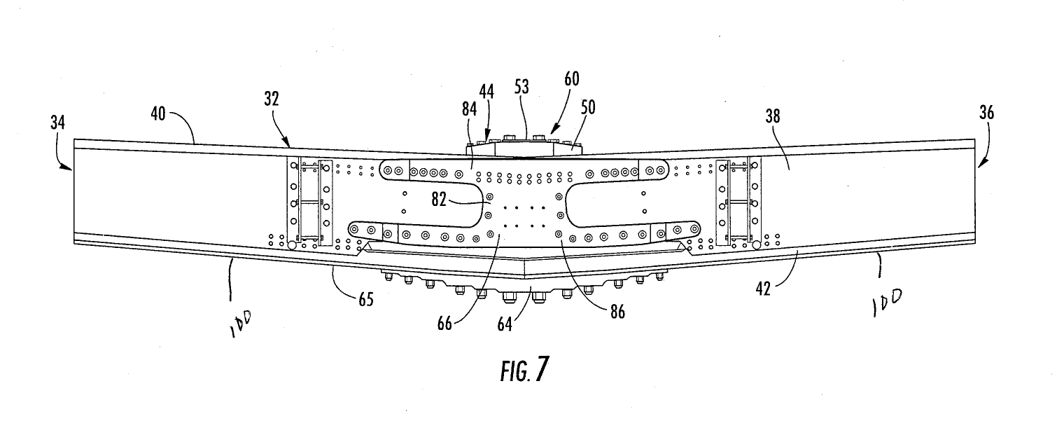

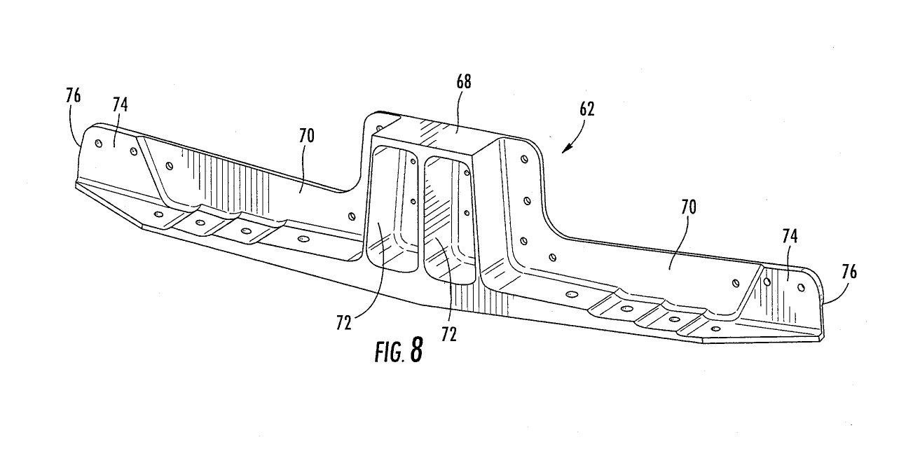

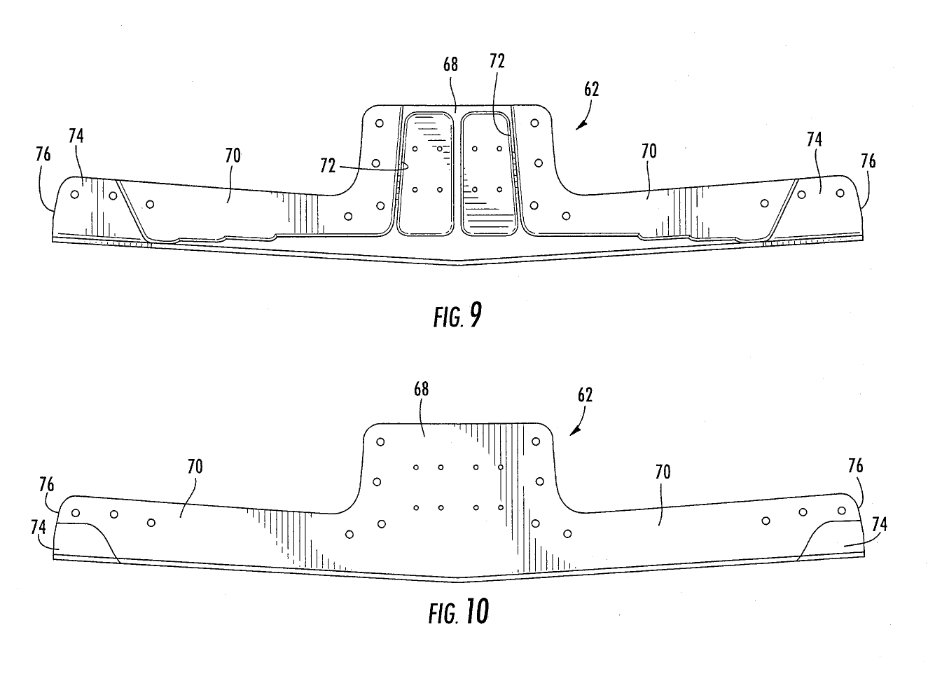

A first embodiment of a spar splice joint for the right portion and left portion of a front spar is shown in FIGS. 3-7, and generally designated at 60. The splice joint comprises a forward splice plate 62, a lower block fitting 64, two lower steel straps 100 and an aft splice plate 66. Referring to FIGS. 8-10, the forward splice plate 62 includes a central portion 68 and two lateral portions 70 extending symmetrically outwardly from the central portion 68. The central portion 68 is the thickest part of the forward splice plate 62 and defines two laterally spaced parallel compartments 72, which open to the front of the forward splice plate 62. The symmetrical lateral portions 70 of the forward splice plate 62 are generally L-shaped in cross-section. The lower leg of the “L” steps down in thickness in a direction away from the central portion 68. The reduction in thickness in the outboard direction causes the forward splice plate 62 to shed load. The lateral portions 70 also have a thicker portion 74 at the terminal ends 76 of the upper leg of the “L”. A plurality of holes are formed in the forward splice plate 62 for receiving fasteners. A plurality of additional holes are drilled during installation to be used to secure the forward splice plate 62 to the front spar 32 and to the other fittings.

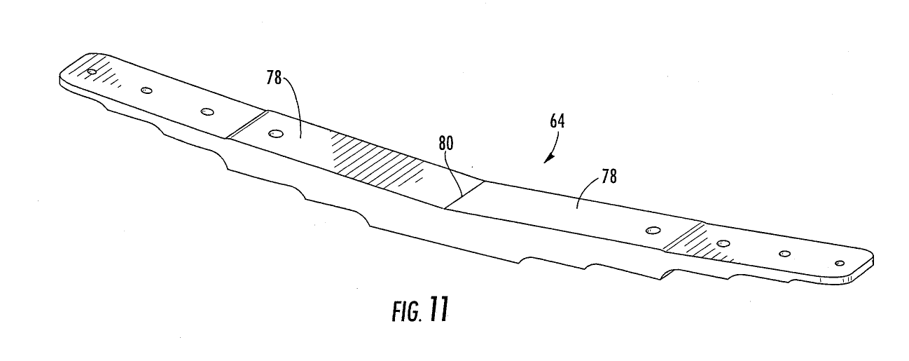

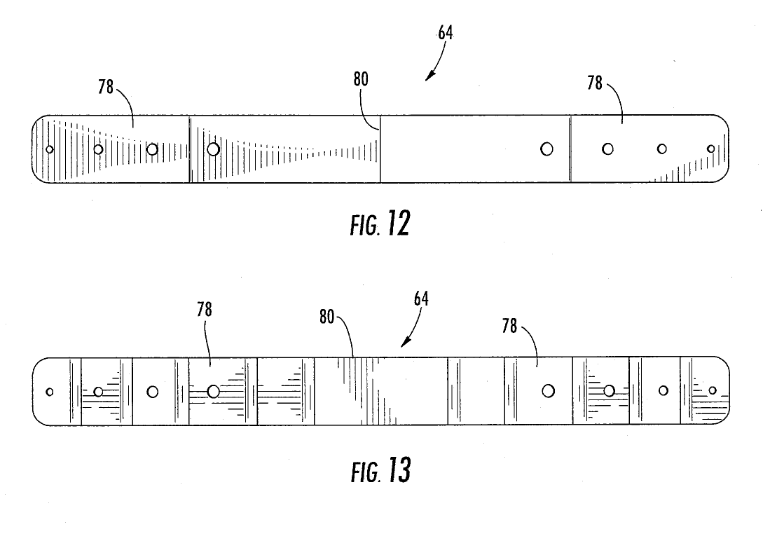

As shown in FIGS. 11-13, the lower block fitting 64 includes two legs 78 extending symmetrically outwardly from a center point 80. The legs 78 step down in thickness in a direction away from the center point 80. A plurality of holes are formed along the longitudinal axis of the lower block fitting 64 for receiving fasteners. A plurality of holes are also drilled during installation to secure the lower block fitting 64 to the forward splice plate 62 and the lower chord 42.

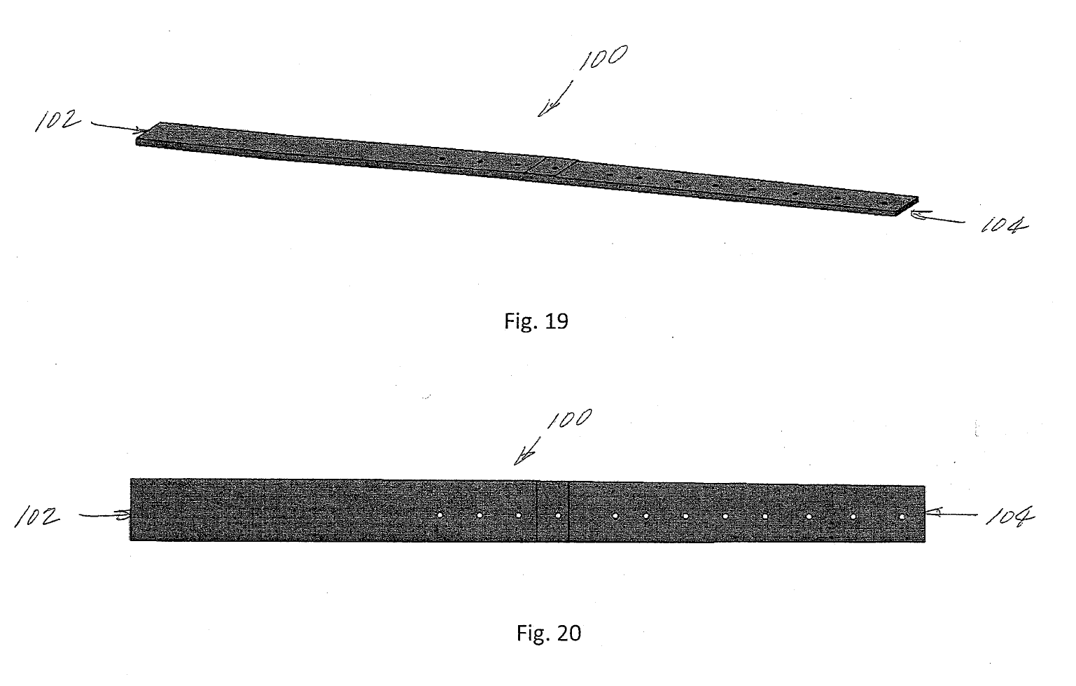

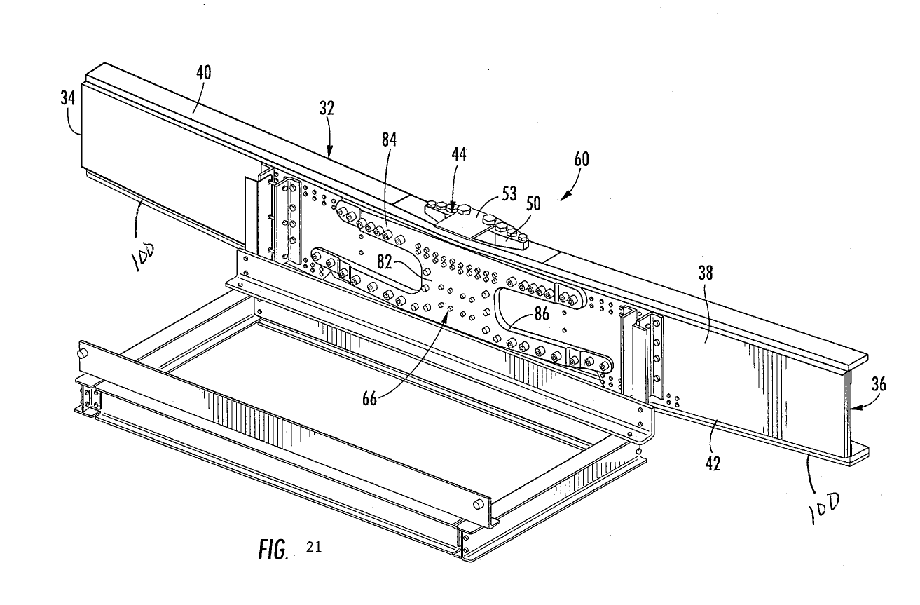

As shown in FIGS. 19 and 20, the steel strap 100 extends longitudinally from 102 to 104. The fitting steps down in thickness in this direction and then is a constant taper outboard of the last machined step. A plurality of holes are formed along the longitudinal axis of the strap for receiving fasteners. A plurality of holes are also drilled during installation to secure the steel strap 100 to the lower spar chord 42 and lower block fitting 64.

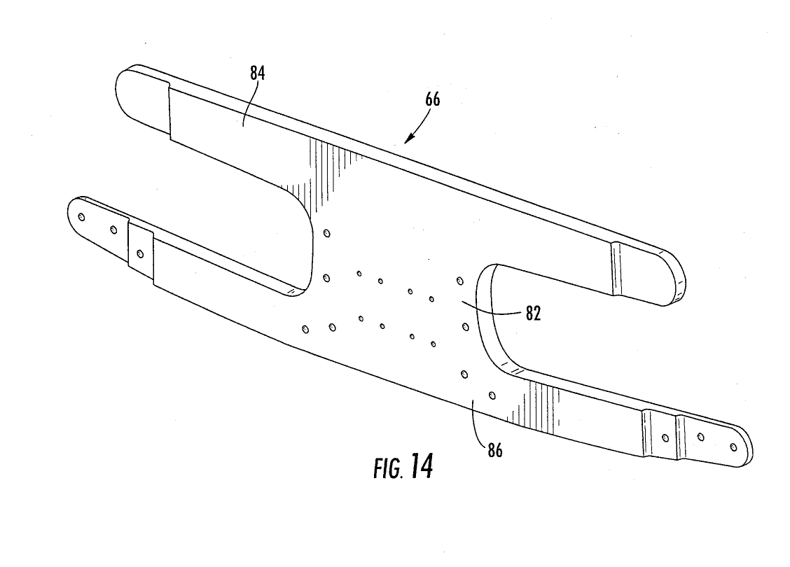

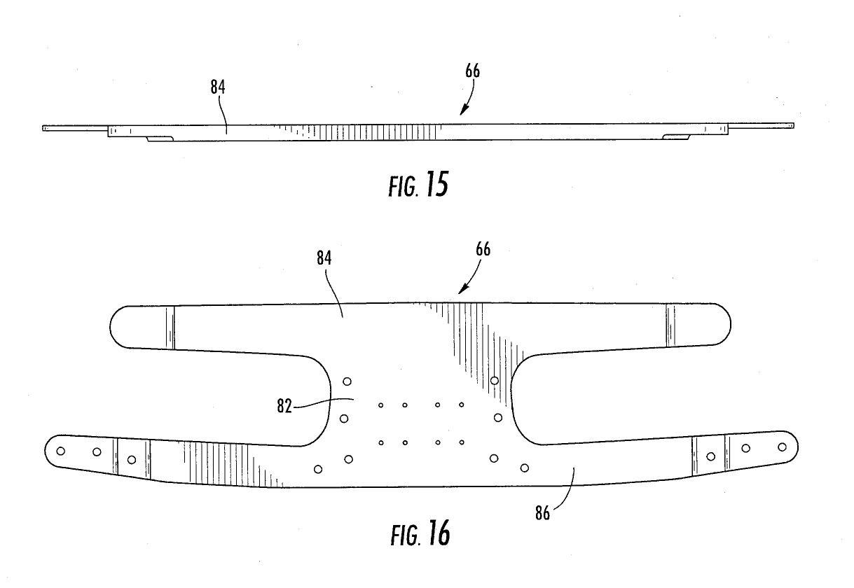

Referring to FIGS. 14-16, the aft splice plate 66 is a generally planar “I” shaped member, including a central portion 82 interconnecting an elongated upper portion 84 and an elongated lower portion 86 extending symmetrically transversely from the central portion 82. The terminal ends of the upper portion 84 and the lower portion 86 step down in thickness. A plurality of holes are formed in the aft splice plate 66, which correspond to the holes in the forward splice plate 62 for receiving fasteners passing through the web 38. A plurality of holes are also drilled in the aft splice plate 66 during installation to secure the aft splice plate to the front spar 32 through the web.

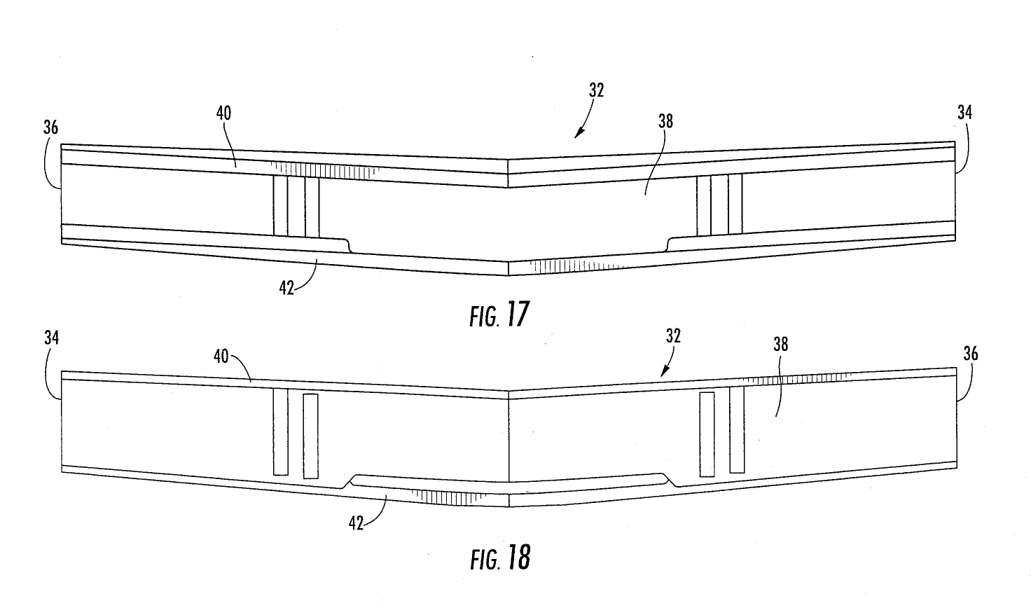

During installation of the spar splice joint 60, the wings of the aircraft are removed from the fuselage. Referring to FIGS. 1 and 2, the lower spar lower fitting 46, the lower spar upper fitting 56 the sleeves 58, and aft spice plate 48 are removed and discarded. A portion of the vertical leg of both of the lower spar chords are removed. All bolts connecting-the upper spar fittings 44 are removed and, along with the upper spar fittings 44, saved for reinstallation. A central portion of the horizontalvertical leg of the lower chord 42 and an adjacent section of the lower edge of the web 38 are removed as shown in FIGS. 17 and 18.

The spar and other fittings may be inspected using high frequency eddy current, especially the holes in the spar cap 44. The wing attach angles (FIG. 18) that are used to attach the front spar 32 to the fuselage frame are also inspected. Freeze plugs are installed in the 2^{nd} and 4^{th} holes from the spar centerline in the lower spar cap.

The lower block fitting 64 and steel strap 100 are then held against the lower surface of the lower chord 42 of the spar 32, aligning the holes in the lower block fitting 64 with exiting hole locations. Holes in the 1^{st} and 3^{rd} outboard hole locations are drilled using existing holes in the lower chord 42 as a guide. A 5^{th} hole location is drilled, if necessary. The forward splice plate 62 is positioned on the forward surface of the web 38, aligning with existing hole locations in the web 38 and chords 40, 42. The 1^{st} hole locations outboard from the centerline are drilled in the upper chord 40 and into the compartments 72 in the forward splice plate 62 and using existing holes in the spar cap 44 as a guide. The opposite outboard hole locations are drilled through the horizontal lower chord 42 legs using the pilot holes in the forward face plate 62. All remaining hole locations in the lower chord 42 and forward splice plate 62 are drilled using hole locations in the lower block fitting 64.

Next, the aft splice plate 66 is placed on the aft surface of the web, positioning the aft splice plate 66 using the pilot holes and existing hole locations in the web 38. A plurality of holes are drilled holes through the web 38 and forward splice plate 62 using the hole locations piloted in forward slice plate. Similarly, a plurality of holes are drilled through the aft splice plate 66 using existing locations in the leg of the upper chord 40 against the web 38. Finally, the existing spar cap 44 is aligned with existing hole locations in upper chord 40. All bolts for the spar cap 44 are reinstalled with the exception of the center bolts, which are new. Fasteners such as bolts, rivets, and the like, are used to secure the fittings of the spar splice joint to the spar 32. Shims are used as appropriate to minimize gaps.

The completed spar assembly is positioned in the fuselage relative to the frame and the wing assembly so that spar can be re-attached to the frame and the wing assembly to the spar.

The spar splice joint described herein has many advantages, including a splice connection can be reworked for extending the safe life of the spar splice up to 50,000 hours. The design solution eliminates questionable fatigue details, wherever possible, zero times existing holes, reduces lower chord stresses and utilizes hole treatment technology to significantly improve fatigue life. The result is reduced ongoing maintenance costs and increased safety.

Although the present invention has been shown and described in considerable detail with respect to a few exemplary embodiments thereof, it should be understood by those skilled in the art that we do not intend to limit the invention to the embodiments since various modifications, omissions and additions may be made to the disclosed embodiments without materially departing from the novel teachings and advantages of the invention, particularly in light of the foregoing teachings. Accordingly, we intend to cover all such modifications, omission, additions and equivalents as may be included within the spirit and scope of the invention as defined by the following claims. In the claims, means-plus-function clauses are intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

We claim:

1. A wing spar joint for coupling the inboard ends of a right wing spar and a left wing spar, each wing spar comprising an elongated structural member including a planar web portion terminating in longitudinal edges, a top chord and a bottom chord extending from the longitudinal edges of the web portion, the top and bottom chords terminating in longitudinal edges and including a flange integral with the longitudinal edge of each of the top chord and the bottom chord, the wing spar joint comprising:
a forward fitting adapted to be disposed against the forward surface of the web portion of the wing spars and spanning the joint defined by the inboard ends of the wing spars;
an aft fitting adapted to be disposed against the aft surface of the web portion of the wing spars and spanning the joint defined by the inboard ends of the wing spars;
a spar cap, including an upper spar cap adapted to be disposed on the upper surface of the flange of the top chord, and a lower spar cap adapted to be disposed on the inner surface of the flange of the top chord, the upper spar cap and the lower spar cap spanning the joint defined by the inboard ends of the wing spars;
a lower chord fitting adapted to be disposed adjacent the lower chord of the wing spars, the lower chord fitting spanning the joint defined by the inboard ends of the wing spars;
a strap member adapted to be disposed between the lower fitting and the lower chord of the wing spars spanning the joint defined by the inboard ends of the wing spars;
a first plurality of fasteners inserted through mating holes in the forward fitting, the web portion, and the aft fitting so as to secure the forward fitting and the aft fitting together through the web portion of the wing spars;
a second plurality of fasteners inserted through mating holes in the upper spar cap, the upper chord, the lower spar cap and the forward fitting for securing the upper spar cap, the lower spar cap and the forward fitting together through the upper chords of the wing spars; and
a third plurality of fasteners inserted through mating holes in the lower chord fitting, the strap member, the lower chord and the forward fitting for securing the lower chord fitting, the strap member and the forward fitting together through the lower chord of the wing spars,
wherein the forward fitting, aft fitting, spar cap and strap member are secured together with the wing spars to form a rigid connecting joint at the inboard ends of the wing spars.
